(19) United States
(12) Patent Application Publication
(10) Pub. No.: US 2026/0062236 A1
(43) Pub. Date: Mar. 5, 2026

(54) LOAD FORMER AND METHOD OF OPERATING A LOAD FORMER

(71) Applicant: A. G. Stacker Inc., Weyers Cave, VA (US)

(72) Inventors: Randall Donn SENGER, Mount Sidney, VA (US); Jerry BLOSSER, Crimora, VA (US); Joseph WUNDER, Lexington, VA (US); Eric STEMPIHAR, Rockingham, VA (US)

(21) Appl. No.: 18/817,325

(22) Filed: Aug. 28, 2024

(51) Int. Cl. B65G 57/03

(52) U.S. Cl. CPC B65G 57/03; B65G 2201/022

(57) ABSTRACT

A load former includes a frame, a loading zone and a horizontal cookie sheet supported by the frame and having a support portion shiftable between a first position in which the support portion is located on a first side of the vertical wall and forms a floor of the loading zone and a second position in which the first portion is located in a holding space on the second side of the vertical wall. A platform is located beneath the loading zone on a lift table. At least one cobot is supported by the frame or mounted in a fixed position relative to the frame and configured to lift a pallet and/or an auxiliary sheet of material and place it in at least one predetermined location on the load former or on at least one object supported by the load former. Also a method of operating the load former.

### TECHNOLOGICAL FIELD

The present disclosure is directed to a load former configured to be operated by a worker with assistance provided by at least one cobot.

### BACKGROUND

Paperboard blanks can be produced by various machines including rotary die cut machines. These blanks exit the rotary die cut machine individually or a small number at a time and are then formed into small stacks or bundles in a known manner. These bundles must then be arranged into larger stacks for transport and storage. For example, through known processes, the blanks may be formed into bundles of 20. If each bundle is 24 inches long by×20 inches wide, four of these bundles can be arranged in a layer having a footprint that corresponds to the 40×48 inch surface of a standard pallet. Assuming each of the bundles is 12 inches high, four to eight of these layers can be stacked one on top of another to form a 48 inch to 96 inch tall stack on the pallet. The dimensions of a standard pallet may be discussed herein, but bundles and/or pallets having different dimensions can also be used.

While the stacks could be formed completely manually, that is, by having a human worker place each of the bundles on a pallet in a pattern and then stack additional bundles on top of the first layer of bundles, this process is inefficient, and it can be difficult to form a final stack that is square. Therefore devices known as load formers are used to partially automate this process.

A conventional load former 100 is schematically illustrated in FIGS. 2 and 3. The load former 100 includes a movable horizontal platform 102, sometimes referred to in the art as a “cookie sheet,” that extends through or past a vertical stop wall 104 and that is bordered at a rear side by a vertical backstop 106. The cookie sheet 102 and the area above the cookie sheet 102 where bundles B are placed may be referred to as the “loading zone” of the load former 100. A support conveyor 108 is located below the cookie sheet 102 on a lift table 110 in a pit 112, and the support conveyor 108 forms a platform for receiving layers of the bundles B from the cookie sheet 102. A first drive 113 shifts the lift table 110 between raised and lowered positions.

A supply conveyor 114 brings bundles B to an operator location 116 where they are accessible to a human operator W, and a take-away conveyor 118 moves finished stacks away from the load former 100. An infeed conveyor 120 carries pallets or bottom sheets 122 to the support conveyor 108. A stack of tie sheets 124 may be located on a platform 126 at the top of the load former 100 generally above the infeed conveyor 120. A controller 128 controls the operation of the various conveyors, the cookie sheet 120 and the lift table 110.

In operation, the controller 128 causes the first drive 113 to lower the lift table 110 until the upper surface of the support conveyor 108 is level with the upper surface of the infeed conveyor 120, and the infeed conveyor 120 and the support conveyor 108 are operated to carry the pallet or bottom sheet 122 along the infeed conveyor 120 and onto the support conveyor 108. The controller 128 then causes the first drive 113 to raise the lift table 110 and hold the support conveyor 108 and the pallet or bottom sheet 122 supported thereon at a location near the bottom of the cookie sheet 102.

At approximately the same time that the pallet or bottom sheet 122 is being moved into position, bundles B arrive at the operator location 116 on the supply conveyor 114, and a human operator manually lifts and/or slides the bundles B from the supply conveyor 114 to the cookie sheet 102. The operator arranges the bundles B on the cookie sheet 102 to form a suitable pattern of the bundles B that will become a layer in a stack on the pallet or bottom sheet 122. For example, as shown in FIG. 3, a first bundle B may be removed from the supply conveyor 114 and moved to position I on the cookie sheet 102 in contact with the stop wall 104 and the backstop 106, a second bundle II may be placed against the first bundle I and the backstop 106, a third bundle III may be placed against the first bundle I and the stop wall 104 and a fourth bundle IV may be placed against the second bundle II and the third bundle III.

With these four bundles in place, the operator pulls a tie sheet 124 from the stack of tie sheets 124 located on the platform 126 and places the tie sheet 124 on top of the bundles B on the cookie sheet 102. The tie sheet 124, which may comprise a sheet of paperboard or thick paper, for example, helps to increase friction between the layers of bundles B in the stack. The operator then presses a button (not illustrated) or otherwise generates a signal to cause the controller 128 to actuate a second drive 130 to retract the cookie sheet 102 through or past the stop wall 104 and into a holding space 131 to deposit the four bundles onto the pallet or bottom sheet 122 on the support conveyor 108.

The controller 128 then operates the first drive 113 to lower the lift table 110 and the support conveyor 108 by a given amount, slightly more than the height of the layer of bundles B, so that the bundles B and the tie sheet 124 thereon are located below the plane of the cookie sheet 102. The controller 128 then re-extends the cookie sheet 102 past the stop wall 104 so that a subsequent layer of bundles can be formed thereon. When the stack on the support conveyor 108 reaches a desired height, the operator may place a final tie sheet 124 on top of the last layer of bundles B (this topmost tie sheet 124 may be referred to as a “top sheet”), and the support conveyor 108 discharges the finished stack onto the take-away conveyor 118 and the process begins again.

The term “auxiliary sheet” may be used herein to refer generically to the pallet or bottom sheet 122, the tie sheets 126 including top sheets and also to sheet-like tags discussed hereinafter and referred to as “load tags.”

Efforts have been made to automate the entire process of bringing bundles B to a load former, arranging them in a pattern on a cookie sheet, forming a stack of layers of bundles and discharging the finished stack from the load former. This can involve the use of industrial robots for orienting and moving bundles and/or special conveyors that can rotate or shift bundles so that they are disposed in a desired pattern before they are pushed onto the cookie sheet. However, full automation can be expensive, and hard guards are required in locations where industrial robots and/or moving machinery could potentially injure workers near the load former. A fully automated load former also has a significantly larger footprint than a fully manual load former. On the other hand, full manual operation of a load former, in which all actions associated with bundles and tie sheets are performed by a worker, may be slow and tedious.

It would therefore be desirable to partially automate a load forming process to make the load former easier and more efficient for a worker to operate but at a lower cost and with a smaller footprint than a fully automated load forming system.

### SUMMARY

These and other problems are addressed by embodiments of the present invention, a first aspect of which comprises a load former in which a worker performs the manual operation of moving bundles into position on a load former cookie sheet and in which a cobot handles the jobs of placing auxiliary sheets, such as bottom sheets, tie sheets and top sheets, into position below, between or on top of layers of bundles. A further cobot may be used to apply a further auxiliary sheet, referred to as a “load tag,” to some of the tie sheets before they are placed on layers of bundles.

A first aspect of the disclosure comprises a load former having a frame, a loading zone bounded by a vertical wall and a horizontal cookie sheet supported by the frame. The cookie sheet has a support portion that is shiftable between a first position in which the support portion is located on a first side of the vertical wall and forms a floor of the loading zone and a second position in which the first portion is located in a holding space on the second side of the vertical wall. The load former includes a platform beneath the loading zone and a lift table configured to raise and lower the platform and a first drive configured to shift the cookie sheet between the first position and the second position and a second drive configured to raise and lower the lift table. At least one cobot is supported by the frame or mounted in a fixed position relative to the frame and configured to lift a pallet and/or an auxiliary sheet of material and place the pallet and/or the auxiliary sheet of material in at least one predetermined location on the load former or on at least one object supported by the load former.

Another aspect of the disclosure comprises a method of using the foregoing load former and includes placing a stack of the auxiliary sheets of material onto an auxiliary sheet supporting region of a platform located above the holding space, manually placing the at least one object on the support portion of the cookie sheet in a predetermined orientation. The method also includes operating a first one of the at least one cobot to lift the auxiliary sheet from the stack of auxiliary sheets, move the auxiliary sheet to the loading zone and place the auxiliary sheet onto the at least one object on the support portion of the cookie sheet, and operating the second drive to shift the cookie sheet to the second position and deposit the at least one object onto the platform, then operating the first drive to lower the platform, and then operating the second drive to shift the cookie sheet to the first position.

A further aspect of the disclosure comprises a method of using the foregoing load former and includes placing a stack of the auxiliary sheets of material onto an auxiliary sheet supporting region of a platform located above the holding space, manually placing the at least one object on the support portion of the cookie sheet in a predetermined orientation, providing a plurality of load tags, operating a first one of the at least one cobot to lift one of the load tags and affix the one of the load tags to an edge of one of the auxiliary sheets, placing the one of the auxiliary sheets onto the at least one object on the support portion of the cookie sheet, and after placing the one of the auxiliary sheets, operating the second drive to shift the cookie sheet to the second position and deposit the at least one object onto the platform, then operating the first drive to lower the platform, and then operating the second drive to shift the cookie sheet to the first position.

### BRIEF DESCRIPTION OF THE DRAWINGS

These and other aspects of the disclosure will be better understood from a reading of the following detailed description together with the attached drawings in which:

FIG. 1 is a perspective view of a semi-manual load former according to an embodiment of the present invention.

FIG. 2 is a schematic side elevational view of the conventional portions of the load former of FIG. 1.

FIG. 3 is a top plan view of a portion of a conventional load former.

### DETAILED DESCRIPTION

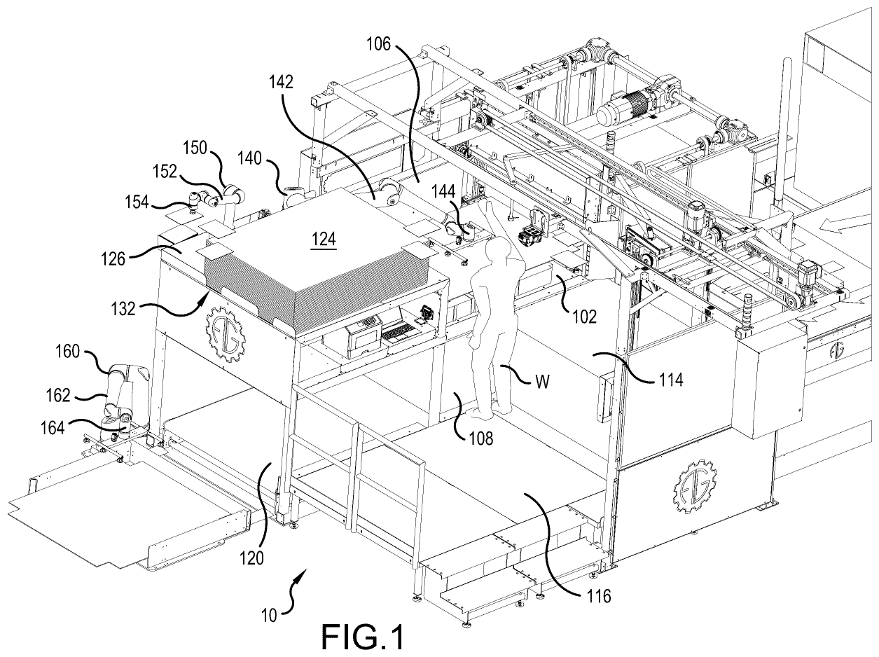

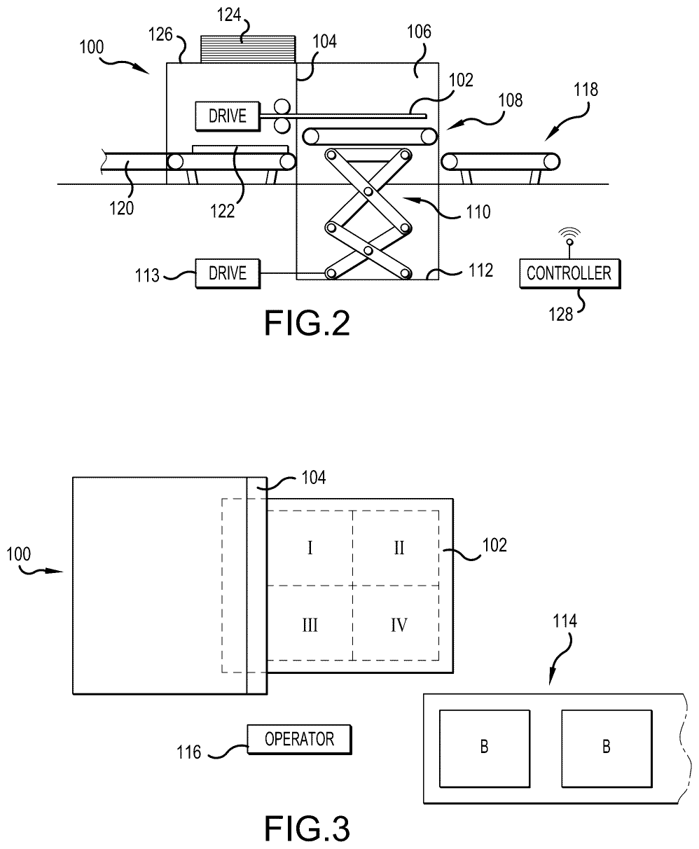

Referring now to the drawings, wherein the showings are for the purpose of illustrating a presently preferred embodiment of the invention only and not for the purpose of limiting same, FIG. 1 shows a load former 10 that includes all the elements of the conventional load former 100 illustrated in FIGS. 2 and 3 including a cookie sheet 102, a support conveyor 108, a supply conveyor 114, an infeed conveyor 120 and a stack of tie sheets 124 located on a platform 126 above the infeed conveyor 120. The specific portion of the platform 126 covered by the tie sheets 124 may be referred to as an “auxiliary sheet supporting region” 132 of the platform 126.

The load former 10 includes a front side 12 and a platform 14 at the front side 12 on which a worker W stands when loading the load former 10. The opposite side of the load former 10 from the worker W is the rear side 16 of the load former 10. The load former 10 also includes a frame 18.

A stack of auxiliary sheets, in this case, tie sheets 124, are stacked on the auxiliary sheet supporting region 132 of the platform 126. This is a common location for storing tie sheets 124 when the load former 10 is used in a fully manual configuration. That is, in a fully manual operation mode, the worker W, standing on the platform 14, can pull individual tie sheets 124 from the platform 126 and place them on top of each finished layer of bundles B on the cookie sheet 102.

The load former 10 according to this embodiment also includes a plurality of collaborative robots, often referred to as “cobots” that perform some of the tasks required of the worker W when the load former is operated in a fully manual configuration. These cobots include a first cobot 140 having a plurality of arm segments 142 and at least one end effector 144 on a distal one of the arm segments 142, a second cobot 150 having a plurality of arm segments 152 and at least one end effector 154 on a distal one of the arm segments 152, and a third cobot 160 having a plurality of arm segments 162 and at least one end effector 164 on a distal one of the arm segments 162.

Unlike conventional industrial robots, the first, second and third cobots 140, 150, 160 are configured to operate in a manner that is unlikely to injure a human operator, and the cobots can therefore be used in locations without the hard guarding that would be required if industrial robots were used. For example, the cobot arms 142, 152, 162 may be configured to operate at relatively low speeds or to produce a limited maximum forces or to include sensors that stop the movement of the cobot arms 142, 152, 162 when resistance is encountered. And if a cobot does accidently contact a worker and come to a stop, the cobot can quickly and easily be reset by the worker to allow work to continue.

Cobots are available commercially from many sources including Yaskawa America Inc., of Waukegan, Il, Universal Robots of Denmark and ABB of Sweden and are discussed in U.S. Pat. No. 5,952,796 entitled “Cobots,” the contents of which patent are hereby incorporated by reference. U.S. Pat. No. 5,952,796 provides examples of early versions of cobots; the present application is not limited to such cobots, and the term “cobot” as used herein is intended to describe any collaborative robot available now or in the future that is capable of performing the functions disclosed herein with a low or zero likelihood of injuring nearby workers.

The first cobot 140 is supported by the frame 18 of the load former 10 and is mounted toward the rear side 16 of the load former 10. The first cobot 140 includes a plurality of arm sections 142 and an end effector 144 at the end of the terminal one of the arm sections 142 that is configured to grasp or engage one of the tie sheets 124 on the stack of tie sheets 124 on the platform 126. The end effector 144 may, for example, comprise one or more vacuum heads that are controllable to selectively secure one of the tie sheets 124 to the end effector 144 using suction and to then release the tie sheet 124 when the suction is reduced or terminated.

The arm sections 142 of the first cobot 140 are articulated in a manner that allows the first cobot 140 to move the end effector 144 to a first position above the stack of the tie sheets 124 and place the end effector 144 against the topmost one of the tie sheets 124 to engage the tie sheet 124 via suction and a second position above the cookie sheet 102 at which the first cobot 140 can place the tie sheet 124 on the cookie sheet 102 or on a layer of bundles B that has been placed on the cookie sheet 102 by an operator. The limited reach of the first cobot 140, combined with controlled speed and force motions, allow for this collaborative work space with the worker W to exist without the need for safety sensors or guards that limit the functions of either the first cobot 140 or the worker W.

The second cobot 150 is located at the rear 16 of the load former 10 at or near the platform 126. A plurality of load tags 170 are supported by a load tag support structure 172. The load tags 170 may have a first portion 174 coated with a pressure sensitive adhesive and a second portion 176 bearing printed and/or machine-readable information related to the bundles B on the bottom sheet or pallet 122 such as information about the nature of the bundles B or delivery or storage or routing instructions for the bundles B. The second cobot 150 is configured so that the end effector 154 can be placed on top of one of the load tags 170 to lift the load tag 170 from the stack of load tags and then moved over the stack of tie sheets 124 on the tie sheet supporting portion 132. In some embodiments, the first cobot 140 may be used to lift and rotate the top tie sheet 124 one or more times so that the second cobot 150 can easily reach the edge locations where the load tag 170 is to be applied. The second cobot 150 is also configured to press the first portion 174 of the load tag 170 against the topmost tie sheet 124 so that the first portion 174 adheres to the tie sheet 124 and the second portion projects outwardly from an edge of the tie sheet 124. If the load tag 170 is pre-creased between the first portion 174 and the second portion 176, the second portion 176 may hang down over the side of the stack of the bundles B.

One or more load tags 170 may be placed along one or more edges of the tie sheets 124 so that when a finished stack of bundles is formed, the second portions 176 of the load tags 170 will be visible to workers or scanning devices positioned to read the information on the second portions 176 of the load tags 170.

Load tags 170 are generally not required on every tie sheet 124. Furthermore, some stacks of bundles may have only one load tag 170, others may have four (one on each side face of the finished stack of bundles) and others may require 10-12 load tags in various positions. The controller 128 is programmed to place the load tags 170 as needed. For example, a finished stack of bundles B may have six layers and require four load tags, one on each face of the bundle, between the third and fourth layer of bundles B in the stack. The controller 128 would therefore not apply load tags 170 to the first two tie sheets 124 in the stack, the ones located between the first and second layers and between the second and third layers, apply one load tag 170 to each edge of the third tie sheet 124 (the one between the third and fourth layers of the stack) and then not apply any load tags 170 to the tie sheets 124 between the final layers of the stack.

Optionally, the second cobot (or an additional cobot—not illustrated) could include a head for applying an adhesive to edge portions of the tie sheets 124 and/or to the first portions 174 of the load tags 170 in the case that load tags without a pressure sensitive adhesive are used. The second cobot 150 may also be configured to crease the load tags 170 between the first portion 174 and the second portion 176 so that the second portion 176 hangs down along the side of a finished stack.

It is possible to program the first cobot 140 to perform the functions of the second cobot 150 as well. However, using two cobots to perform these separate functions is preferred in this embodiment.

The third cobot 160 is located near the infeed conveyor 120 and is configured to place pallets or bottom sheets 122 onto the infeed conveyor 120. The arm segments 162 of the third cobot 160 are configured to allow the cobot to move the end effector 164 above a source of pallets or bottom sheets 122, lift one of the pallets or bottom sheets 122 and place the pallet or bottom sheet 122 onto the infeed conveyor 120. When the pallet or bottom sheet 122 is a pallet, the end effector may be configured to grip the pallet rather than lift it by means of a vacuum.

It is preferred that some or all of the first, second and third cobots 140, 150, 160 are mounted on or directly supported by the frame 18 of the load former 10. In this manner, the footprint of the load former 10 is increased minimally or not at all as compared to a conventional load former and is significantly smaller than the footprint of a fully automated load forming system.

In operation, when the load former 10 is powered on, the third cobot 160 moves its end effector 164 over the stack of pallets or bottom sheets 122, grasps or otherwise engages (via a vacuum-type end effector, for example) one of the pallets or bottom sheets 122 and places the pallet or bottom sheet 122 onto the infeed conveyor 120. The controller 128 operates the infeed conveyor 120 to bring the pallet or bottom sheet 122 to the support conveyor 108 and operates the support conveyor 108 to bring the pallet or bottom sheet 122 fully onto the support conveyor 108. The controller 128 then controls the first drive 113 to raise the lift table 110 and the support conveyor 108 and the pallet or bottom sheet 122 supported thereby to a position below the cookie sheet 102.

Bundles B move toward the worker W on the supply conveyor 114, and the worker W begins removing the bundles B from the supply conveyor 114 and placing them on the cookie sheet 102 in a predetermined pattern. During this time, the second cobot 150 may be affixing a desired number of the load tags 170 on the tie sheets 124 on the platform 126. When the last bundle B is in place, the worker presses a button (not illustrated) or otherwise produces a signal to cycle the load former 10 at which time the first cobot 140 lifts the top tie sheet 124 from the stack of tie sheets on the platform 126, which tie sheet 124 has the required number (zero or more) of load tags 170 already attached thereto, and places the tie sheet 124 on top of the just-formed layer of bundles B. The controller 128 then operates the second drive 113 to retract the cookie sheet 102 past the stop wall 104 to deposit the layer of bundles B with the tie sheet 124 onto the pallet or bottom sheet 122 on the support conveyor 108 and then re-extends the cookie sheet 102 to start another cycle.

It has been found that the process of manually placing tie sheets 124 can take almost as much time as the layer-forming operation itself. This is in part because the worker W must slide a tie sheet 124 from a stack and ensure that it is properly aligned with the bundles B on the cookie sheet 102 before cycling the load former. The first cobot 140 can perform this process repeatedly and in a precise manner without the need to check every tie sheet 124 for proper alignment The present disclosure can therefore noticeably improve the throughput of a load former 10.

Furthermore, the conventional process of placing load tags 170 in a stack of bundles often involves a worker physically separating the bundles of a finished stack (downstream from the load former) to form gaps between the bundles and then inserting a required number of load tags into the gaps. This process can potentially damage the bundles and is very time consuming. By pre-applying the load tags 170 to some of the tie sheets 124 before placing the tie sheets onto the bundles B, the need to separate and insert load tags downstream from the load former is eliminated, further streamlining the stack formation process. The second cobot 150 can be used to apply load tags 170 to the tie sheets 124 even in applications where the first cobot 140 is not present and the tie sheets are manually placed on the bundles B by the worker W.

The present invention has been described herein in terms of presently preferred embodiments. Modifications and additions to these embodiments will become apparent to persons of ordinary skill in the art upon a reading of the foregoing disclosure. It is intended that all such modifications and additions form a part of the present invention to the extent they fall within the scope of the several claims appended hereto.

What is claimed is:

1. A load former comprising:
a frame,
a loading zone bounded by a vertical wall,
a horizontal cookie sheet supported by the frame and having a support portion shiftable between a first position in which the support portion is located on a first side of the vertical wall and forms a floor of the loading zone and a second position in which the first portion is located in a holding space on the second side of the vertical wall,
a platform beneath the loading zone,
a lift table configured to raise and to lower the platform,
a first drive configured to shift the cookie sheet between the first position and the second position,
a second drive configured to raise and lower the lift table, and
at least one cobot supported by the frame or mounted in a fixed position relative to the frame and configured to lift a pallet and/or an auxiliary sheet of material and place the pallet and/or the auxiliary sheet of material in at least one predetermined location on the load former or on at least one object supported by the load former.

2. The load former according to claim 1,
wherein the at least one cobot is supported by the frame.

3. The load former according to claim 1,
wherein the at least one cobot is configured to lift the pallet and to place the pallet onto a conveyor located beneath the holding space.

4. The load former according to claim 1,
wherein the at least one cobot is configured to lift the auxiliary sheet of material, and
wherein the at least one predetermined location on the load former or an object supported by the load former is a location on the platform or a location on an object supported by the platform or a location on the support portion of the cookie sheet or a location on an object supported by the support portion of the cookie sheet.

5. The load former according to claim 4,
including a platform located above the holding space, the platform having an auxiliary sheet supporting region configured to support a stack of a plurality of the auxiliary sheets.

6. The load former according to claim 5,
wherein the at least one cobot comprises a first cobot having a first end effector, and
wherein the first cobot is shiftable from a first configuration in which the first end effector is located over the auxiliary sheet supporting region and a second configuration in which the first end effector is located in or above the loading zone.

7. The load former according to claim 6,
wherein the at least one cobot comprises a second cobot having a second end effector, and
wherein the second cobot is shiftable from a first configuration in which the second end effector is located over the auxiliary sheet supporting region and a second configuration in which the second end effector is not located over the auxiliary sheet supporting region.

8. The load former according to claim 6,
wherein the first cobot and the second cobot are supported by the frame.

9. The load former according to claim 1,
wherein the at least one cobot includes an end effector, and
wherein the at least one cobot is shiftable from a first configuration in which the end effector is located over the auxiliary sheet supporting region and a second configuration in which the end effector is not located over the auxiliary sheet supporting region.

10. The load former according to claim 5,
wherein the at least one cobot comprises a first cobot having a first end effector and a second cobot having a second end effector,
wherein the first cobot is configured to lift the auxiliary sheet from the stack of the auxiliary sheets and place the auxiliary sheet in or above the loading zone, and
wherein the second cobot is configured to lift a load tag from a location outside the auxiliary sheet supporting region and place the load tag onto one of the plurality of auxiliary sheets in the stack of auxiliary sheets.

11. The load former according to claim 5,
wherein the at least one cobot comprises a first cobot having a first end effector, and
wherein the first cobot is configured to lift a load tag from a location outside the auxiliary sheet supporting region and place the load tag onto one of the plurality of auxiliary sheets in the stack of auxiliary sheets.

12. A method comprising:
providing a load former according to claim 1,
placing a stack of the auxiliary sheets of material onto an auxiliary sheet supporting region of a platform located above the holding space,
manually placing the at least one object on the support portion of the cookie sheet in a predetermined orientation,
operating a first one of the at least one cobot to lift the auxiliary sheet from the stack of auxiliary sheets, move the auxiliary sheet to the loading zone and place the auxiliary sheet onto the at least one object on the support portion of the cookie sheet, and
operating the second drive to shift the cookie sheet to the second position and deposit the at least one object onto the platform, then operating the first drive to lower the platform, and then operating the second drive to shift the cookie sheet to the first position.

13. The method according to claim 12,
wherein the first one of the at least one cobot is supported by the frame.

14. The method according to claim 12, including:
providing a plurality of load tags, and
operating a second one of the at least one cobot to lift one of the load tags and affix the one of the load tags to an edge of one of the auxiliary sheets before operating the first one of the at least one cobot to lift the auxiliary sheet from the stack of auxiliary sheets.

15. The method according to claim 14,
wherein the first one of the at least one cobot is supported by the frame.

16. The method according to claim 14, including:
providing a plurality of the pallets and/or auxiliary sheets, and
operating a third one of the at least one cobot to move one of the plurality of pallets onto a conveyor located beneath the holding space.

17. A method comprising:
providing a load former according to claim 1,
placing a stack of the auxiliary sheets of material onto an auxiliary sheet supporting region of a platform located above the holding space,
manually placing the at least one object on the support portion of the cookie sheet in a predetermined orientation,
providing a plurality of load tags,
operating a first one of the at least one cobot to lift one of the load tags and affix the one of the load tags to an edge of one of the auxiliary sheets,
placing the one of the auxiliary sheets onto the at least one object on the support portion of the cookie sheet, and
after placing the one of the auxiliary sheets, operating the second drive to shift the cookie sheet to the second position and deposit the at least one object onto the platform, then operating the first drive to lower the platform, and then operating the second drive to shift the cookie sheet to the first position.
